(19) United States
(12) Patent Application Publication
(10) Pub. No.: US 2020/0117166 A1
(43) Pub. Date: Apr. 16, 2020

(54) MACHINING INFORMATION RECORDING DEVICE, MACHINING INFORMATION RECORDING METHOD AND NON-TRANSITORY COMPUTER READABLE MEDIUM RECORDING PROGRAM

(71) Applicant: FANUC CORPORATION, Yamanashi (JP)

(72) Inventor: Tohru MIZUNO, Yamanashi (JP)

(73) Assignee: FANUC CORPORATION, Yamanashi (JP)

(21) Appl. No.: 16/597,154

(22) Filed: Oct. 9, 2019

(30) Foreign Application Priority Data
Oct. 12, 2018 (JP) 2018-193256

(51) Int. Cl. G05B 19/406; G05B 19/4097

(52) U.S. Cl. CPC G05B 19/406; G05B 2219/37088; G05B 19/4097

(57) ABSTRACT

An object of the present invention is to more appropriately acquire machining information on a machine tool. A machining information recording device of the present invention includes: a machining monitor unit (state amount acquisition unit) which acquires a state amount indicating the state of machining performed with a machine tool; and a performance management unit (an acquisition condition setting unit, an acquisition control unit) which sets, based on the state of the machining, a state amount acquisition condition for acquiring the state amount and which controls the acquisition of the state amount based on the state amount acquisition condition that is set.

This application is based on and claims the benefit of priority from Japanese Patent Application No. 2018-193256, filed on 12 Oct. 2018, the content of which is incorporated herein by reference.

### BACKGROUND OF THE INVENTION

### Field of the Invention

The present invention relates to a machining information recording device, a machining information recording method and a non-transitory computer readable medium which records a program.

### Related Art

Conventionally, a technology is known in which in a machine tool that performs machining of a workpiece and the like, a state amount (hereinafter also referred to as “machining information”) which indicates the state of machining is acquired by sampling during the machining. In such a technology, the state amount and a sampling cycle which are acquired may be changed according to the purpose. This type of technology has been disclosed in, for example, Patent Document 1.

Patent Document 1: Japanese Unexamined Patent Application, Publication No. 2018-24086

### SUMMARY OF THE INVENTION

However, in the conventional technology, the type of state amount and the sampling cycle which are acquired cannot be changed according to the state of machining of the workpiece being machined. Hence, in order to obtain a desired state amount, it is necessary to perform the same machining again. Although a method can be considered which previously acquires all state amounts in sufficiently short cycles, in this case, it is disadvantageously necessary to provide a large amount of storage memory or to perform processing for taking a significant state amount from collected data. On the other hand, when a specific machined shape and a state amount at the time of machining using a tool are acquired, and the acquisition is assumed to be realized with a current G code program, processing for acquiring a state amount only in a desired place needs to be added by correcting a machining program. In other words, in the conventional technology, it is difficult to appropriately acquire machining information on a machine tool.

An object of the present invention is to more appropriately acquire machining information on a machine tool.

(1) A machining information recording device (for example, a machining information recording device 1 which will be described later) according to an aspect of the present invention includes: a state amount acquisition unit (for example, a machining monitor unit 11g which will be described later) which acquires a state amount indicating the state of machining that is performed with a machine tool (for example, a CNC machine tool 4 which will be described later); an acquisition condition setting unit (for example, a performance management unit 11f which will be described later) which sets, based on the state of the machining, a state amount acquisition condition for acquiring the state amount; and an acquisition control unit (for example, a performance management unit 11f which will be described later) which controls the acquisition of the state amount by the state amount acquisition unit based on the state amount acquisition condition set by the acquisition condition setting unit.

(2) Preferably, in the machining information recording device of (1), the acquisition condition setting unit sets, based on the state of the machining, as the state amount acquisition condition, at least any one of the state amount which is acquired in a machining step included in the machining and a sampling cycle for acquiring the state amount.

(3) Preferably, in the machining information recording device of (1) or (2), when the details of a machining step included in the machining satisfy a preset condition, the acquisition condition setting unit sets, as the state amount acquisition condition, the state amount acquired in the machining step.

(4) Preferably, in the machining information recording device of (1) to (3), the acquisition condition setting unit sets, based on machining command data for the machining, the state amount acquisition condition for acquiring the state amount in a machining step included in the machining before the machining is performed.

(5) A machining information recording device (for example, a machining information recording device 1 which will be described later) according to an aspect of the present invention includes: a machining information evaluation unit (for example, a machining information evaluation unit 11h which will be described later) which references a database (for example, a machining information DB 1A) storing machining command data of machining performed with a machine tool (for example, a CNC machine tool 4 which will be described later) and data of a state amount acquired in the machining and indicating the state of the machining so as to evaluate the effectiveness of a state amount acquisition condition indicating an acquisition condition when the state amount is acquired in the machining; an acquisition condition setting unit (for example, a performance management unit 11f which will be described later) which sets, for each of machining steps included in the machining command data serving as a target to be performed, based on the details of machining in the machining step and the result of the evaluation of the machining information evaluation unit, the state amount acquisition condition for the machining step; a machining performance unit (for example, a performance management unit 11f which will be described later) which performs, based on the state amount acquisition condition for each of the machining steps that is set by the acquisition condition setting unit, the machining of a workpiece with the machining command data serving as the target to be performed; and a state amount acquisition unit (for example, a machining monitor unit 11g which will be described later) which acquires a state amount indicating a state of the machining of the workpiece performed by the machining performance unit.

(6) A machining information recording method according to an aspect of the present invention includes: a state amount acquisition step of acquiring a state amount indicating the state of machining that is performed with a machine tool; an acquisition condition setting step of setting, based on the state of the machining, a state amount acquisition condition for acquiring the state amount; and an acquisition control step of controlling the acquisition of the state amount in the state amount acquisition step based on the state amount acquisition condition set in the acquisition condition setting step.

(7) A machining information recording method according to an aspect of the present invention includes: a machining information evaluation step of referencing a database storing machining command data of machining performed with a machine tool and data of a state amount acquired in the machining and indicating the state of the machining so as to evaluate the effectiveness of a state amount acquisition condition indicating an acquisition condition when the state amount is acquired in the machining; an acquisition condition setting step of setting, for each of machining steps included in the machining command data serving as a target to be performed, based on the details of machining in the machining step and the result of the evaluation of the machining information evaluation unit, the state amount acquisition condition for the machining step; a machining performance step of performing, based on the state amount acquisition condition for each of the machining steps that is set in the acquisition condition setting step, the machining of a workpiece with the machining command data serving as the target to be performed; and a state amount acquisition step of acquiring a state amount indicating the state of the machining of the workpiece performed in the machining performance step.

(8) A non-transitory computer readable medium recording a program according to an aspect of the present invention that instructs a computer to realize: a state amount acquisition function of acquiring a state amount indicating the state of machining that is performed with a machine tool; an acquisition condition setting function of setting, based on the state of the machining, a state amount acquisition condition for acquiring the state amount; and an acquisition control function of controlling the acquisition of the state amount in the state amount acquisition function based on the state amount acquisition condition set in the acquisition condition setting function.

(9) A non-transitory computer readable medium recording a program according to an aspect of the present invention that instructs a computer to realize: a machining information evaluation function of referencing a database storing machining command data of machining performed with a machine tool and data of a state amount acquired in the machining and indicating the state of the machining so as to evaluate the effectiveness of a state amount acquisition condition indicating an acquisition condition when the state amount is acquired in the machining; an acquisition condition setting function of setting, for each of machining steps included in the machining command data serving as a target to be performed, based on the details of machining in the machining step and the result of the evaluation of the machining information evaluation function, the state amount acquisition condition for the machining step; a machining performance function of performing, based on the state amount acquisition condition for each of the machining steps that is set in the acquisition condition setting function, the machining of a workpiece with the machining command data serving as the target to be performed; and a state amount acquisition function of acquiring a state amount indicating the state of the machining of the workpiece performed in the machining performance function.

According to the present invention, it is possible to more appropriately acquire machining information on a machine tool.

### BRIEF DESCRIPTION OF THE DRAWINGS

FIG. 1 is a schematic view showing the system configuration of a machining information recording system according to an embodiment of the present invention;

FIG. 2 is a schematic view showing the data structure of machining command data and machining performance data;

FIG. 3 is a schematic view showing an example of data of a working step in the machining command data;

FIG. 4 is a block diagram showing the configuration of a machining information recording device;

FIG. 5 is a schematic view showing a specific example of the machining performance data;

FIG. 6 is a flowchart illustrating the flow of machining performance processing which is performed by the machining information recording device;

FIG. 7 is a flowchart illustrating the flow of the machining performance processing which is performed by the machining information recording device;

FIG. 8 is a block diagram showing the configuration of a machining information recording device according to a third embodiment;

FIG. 9 is a flowchart illustrating the flow of machining information evaluation processing which is performed by the machining information recording device; and

FIG. 10 is a flowchart illustrating the flow of machining performance processing which is performed by the machining information recording device.

### DETAILED DESCRIPTION OF THE INVENTION

Embodiments of the present invention will be described below with reference to drawings.

### First Embodiment

### [Configuration]

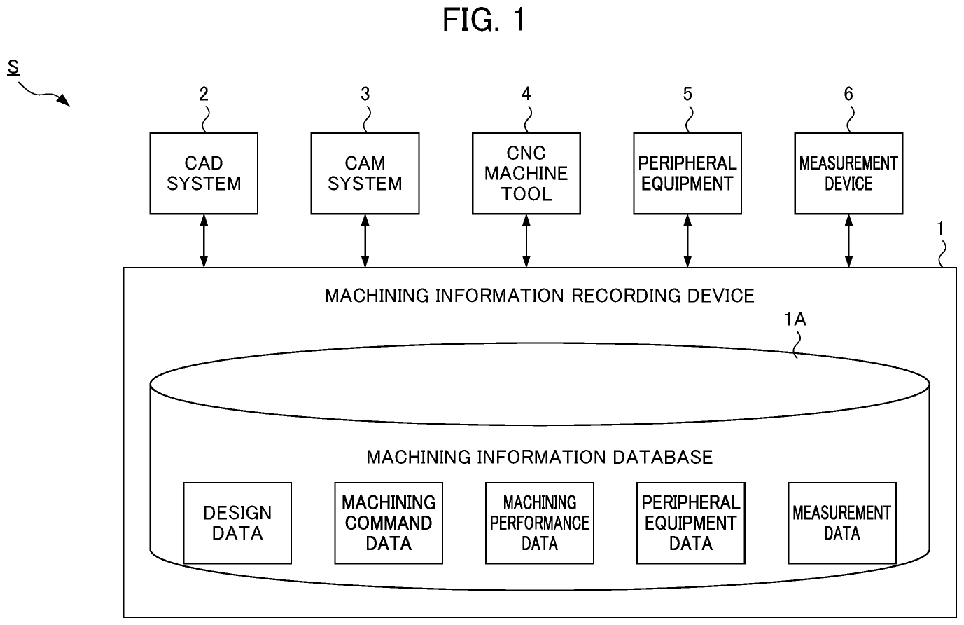

FIG. 1 is a schematic view showing the system configuration of a machining information recording system S according to an embodiment of the present invention. In the machining information recording system S according to the present embodiment, machining performance data (data of a machining history) in machining which is performed according to machining command data in a production process is acquired by a machining information recording device 1, and is stored in a machining information database 1A (recorded as the machining history). In the present embodiment, the machining command data is described as structured data having a hierarchical structure, and when the machining is performed, machining units (WS: working steps) which are made to correspond to a machined shape, a machining method, a tool and the like are provided as constituent elements. In the machining information recording system S according to the present embodiment, when the machining information recording device 1 acquires the machining performance data, state amount acquisition conditions such as a state amount indicating the state of the machining and a sampling cycle for acquisition of the state amount are changed according to the state of the machining for each of the machining units. Hence, with the machining information recording system S according to the present embodiment, it is possible to more appropriately acquire machining information on a machine tool.

As shown in FIG. 1, the machining information recording system S includes the machining information recording device 1, a CAD (Computer Aided Design) system 2, a CAM (Computer Aided Manufacturing) system 3, a CNC (Computerized Numerical Control) machine tool 4, peripheral equipment 5 and a measurement device 6. The machining information recording device 1, the CAD system 2 the CAM system 3 the CNC machine tool 4 and the measurement device 6 are configured such that they can communicate with a network such as a wired or wireless LAN or a communication cable such as a USB (Universal Serial Bus) cable. Time information in the individual devices of the machining information recording system S is synchronized, and time stamps of generated data are based on the reference of a unified time.

The machining information recording device 1 includes the machining information database (machining information DB) 1A for storing design data, the machining command data, the machining performance data, data of the peripheral equipment, and measurement data such that the individual pieces of data are made to correspond to each other. In the present embodiment, in the machining information DB 1A, data is stored which is collected not only in a case where processing is performed by the machining information recording device 1 but also in a case where processing is performed by devices other than the machining information recording device 1.

The design data includes product shape data and process design data. The product shape data is two-dimensional or three-dimensional CAD data which is generated in the CAD system 2, and the process design data is CAM data in which the machining method or a machining order and the like generated in the CAM system are defined.

The machining command data is data which is formed with the aggregation of working steps indicating the basic patterns of machining operations. In the present embodiment, the machining command data is described as the structured data having the hierarchical structure. The machining performance data is data which indicates the history of the machining that is performed based on the machining command data. In the present embodiment, the machining performance data is described as structured data having a hierarchical structure corresponding to the machining command data. The data of the peripheral equipment is data of peripheral equipment, such as a vice, a chuck or tooling, which is used in the machining. The measurement data is data which is measured with a measurement device, such as an acoustic sensor, a temperature sensor or a dimension measurement device, that is installed as an external device of the CNC machine tool 4.

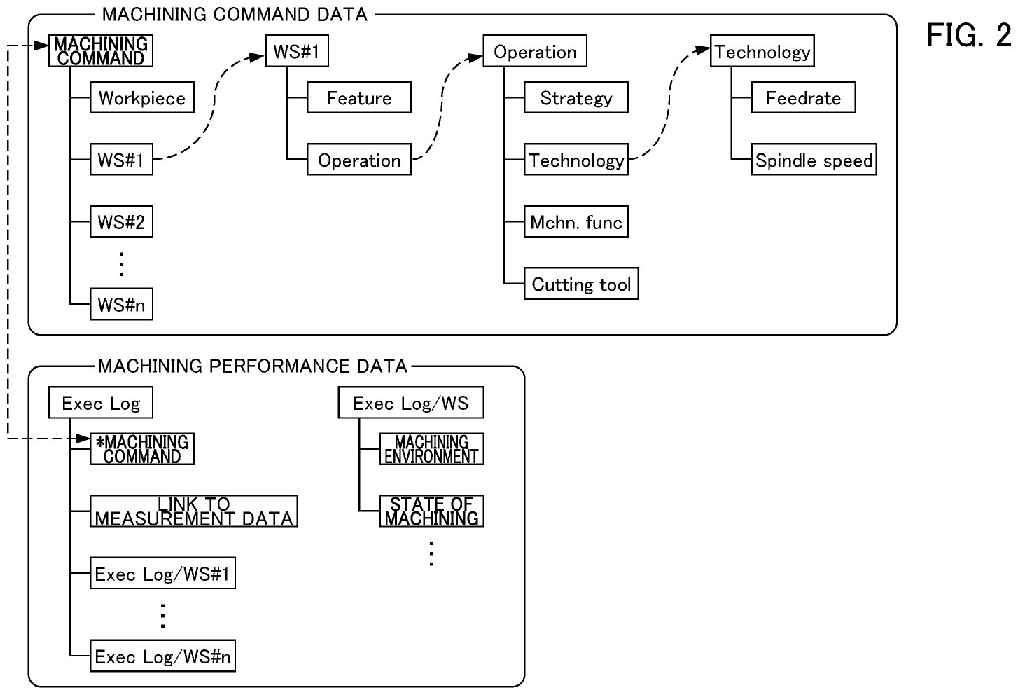

FIG. 2 is a schematic view showing the data structure of the machining command data and the machining performance data. FIG. 2 shows an example of the conception of the machining command data and the machining performance data, and specific details (such as the form of a hierarchy and the items of data) of the machining command data and the machining performance data differ according to the details of the actual machining.

As shown in FIG. 2, the machining command data includes: data of a workpiece indicating a target to be machined; and data of the working steps (WS) indicating the basic patterns (machining units) of the first to nth (n is a natural number) machining operations in order of the machining. An ID for identifying the machining command data is provided to the machining command data. The data of each of the working steps includes: data of a feature indicating a machined shape such as a pocket; and data of an operation indicating a machining method.

The data of the operation includes: data of a strategy indicating a machining strategy (pattern of a machining path); data of a technology indicating cutting conditions; data of a machine function (Mchn. func) indicating the function of the CNC machine tool 4 used in the machining; and data of a cutting tool indicating the tool which is used in the machining. The data of the technology further includes: data of a feed rate indicating the feed rate of the tool; and data of a spindle speed indicating the rotation speed (spindle rotation) of a spindle.

As shown in FIG. 2, the machining performance data includes: data of a machining command ID for identifying the corresponding machining command data; data of link information indicating the storage region of the measurement data obtained by measuring the result of the machining; and data of an execution log (Exec Log) indicating the history of the machining in each of the first to nth working steps in order of the machining. The data of the execution log includes: data indicating the environment of the machining such as the temperature; and data indicating the state of the machining such as a spindle load.

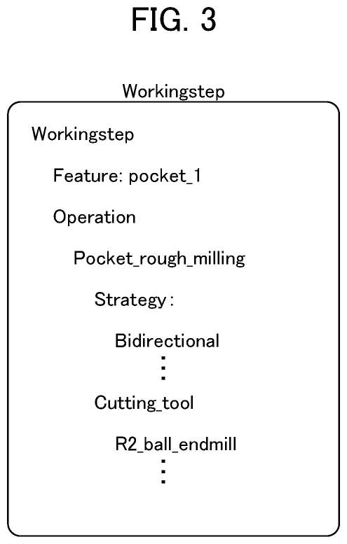

FIG. 3 is a schematic view showing an example of data of the working step in the machining command data. As shown in FIG. 3, the data of one working step is hierarchically included in the machining command data, and the specific details of the data of the feature indicating the machined shape and the data of the operation indicating the machining method are described.

For example, in FIG. 3, as the data of the feature indicating the machined shape, “pocket_1” indicating the shape of “pocket 1” is described. As the data of the operation indicating the machining method, “Pocket_rough_milling” indicating “roughing” is described. As the data of the strategy indicating the machining strategy (the pattern of the machining path), “Bidirectional” indicating that the machining path is a round-trip path is described. As the data of the cutting tool indicating the tool used in the machining, “R2_ball_endmill” indicating a predetermined type of endmill is described. As described above, the machining command data is structured, and thus as compared with a case where the machining command is simply described in a G code format (unstructured format), it is easy to grasp the flow of the entire machining.

The CAD system 2 generates, according to the operation of a user, two-dimensional or three-dimensional CAD data indicating the shape of a product. The CAM system 3 generates, according to the operation of the user, the process design data in which the machining method (such as the type of machining technology used) for machining the product or the machining order (such as a machining path when the product is machined) is defined.

The CNC machine tool 4 includes a numerical controller which uses numerical control so as to control an operation, and performs, according to the control of the numerical controller, the machining such as cutting or polishing on a material that is to become the product. The CNC machine tool 4 acquires, with the numerical controller, various types of data (such as data of the position and speed of a servo) on the state of the operation. The peripheral equipment 5 is peripheral equipment such as a vice, a chuck or tooling, which is used in the machining. The measurement device 6 is a measurement device, such as a temperature sensor or a dimension measurement device, which is installed as an external device of the CNC machine tool 4.

[Configuration of Machining Information Recording Device 1]

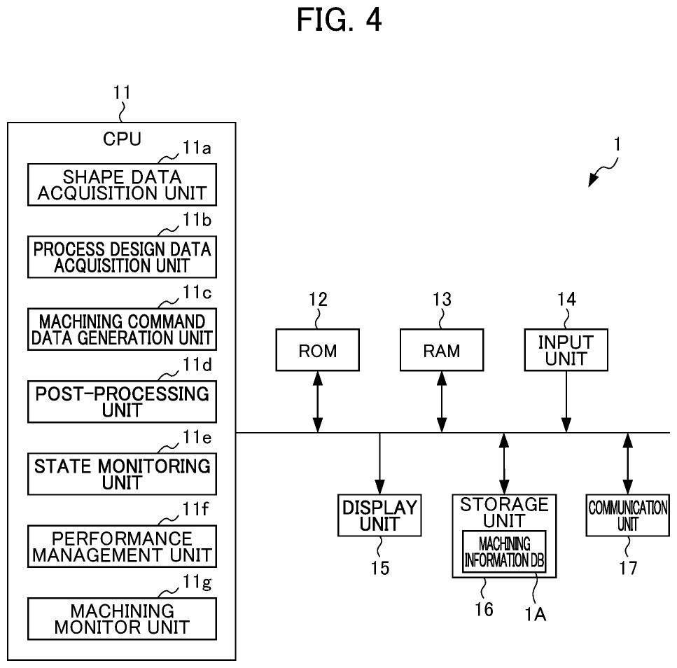

The configuration of the machining information recording device 1 will be described next. FIG. 4 is a block diagram showing the configuration of the machining information recording device 1. As shown in FIG. 4, the machining information recording device 1 includes a CPU (Central Processing Unit) 11, a ROM 12, a RAM 13, an input unit 14, a display unit 15, a storage unit 16 and a communication unit 17.

The CPU 11 executes various types of programs stored in the storage unit 16 so as to control the entire machining information recording device 1. For example, the CPU 11 executes a program for processing (hereinafter referred to as “machining performance processing”) which performs the machining on the product.

When the machining performance processing is performed, in the CPU 11, as a functional configuration, a shape data acquisition unit 11a, a process design data acquisition unit 11b, a machining command data generation unit 11c, a post-processing unit 11d, a state monitoring unit 11e, a performance management unit 11f which also functions as an acquisition condition setting unit and an acquisition control unit and a machining monitor unit 11g which also functions as a state amount acquisition unit are formed.

The shape data acquisition unit 11a acquires the two-dimensional or three-dimensional CAD data (product shape data) generated in the CAD system 2 and indicating the shape of the product, and stores it in the machining information DB 1A. The process design data acquisition unit 11b acquires the process design data generated in the CAM system, and stores it in the machining information DB 1A. The process design data includes CL (Cutter Location) data indicating the machining path when the product is machined.

The machining command data generation unit 11c generates, based on the process design data, the machining command data which includes the working steps indicating the basic patterns of the machining operations. As the basic patterns indicated by the working steps, for example, individual patterns such as the machining of the side surface of the pocket, a pocket shape, the pattern of the machining path, a cut in a radial direction, a cut in an axial direction, the feed rate, the spindle rotation, an approach pattern and a retract pattern can be defined.

Based on the machining command data, the post-processing unit 11d performs the post-processing, uses an interpreter corresponding to the numerical controller of the CNC machine tool 4 and thereby generates the machining path in a machine coordinate system. Then, the post-processing unit 11d outputs the machining command data indicating the machining path in the machine coordinate system and the data of parameters for CNC (hereinafter referred to as “numerical control command data” as necessary) to the numerical controller of the CNC machine tool 4.

The state monitoring unit 11e monitors the state of the CNC machine tool 4 controlled by the numerical controller (for example, the occurrence of an alert indicating that the tool needs to be replaced).

The performance management unit 11f manages the machining performance processing (machining processing based on the machining command data) for performing the machining of the product. For example, the performance management unit 11f receives, from the numerical controller of the CNC machine tool 4, a signal indicating that the standby of the CNC machine tool 4 is completed so as to provide an instruction to start the machining based on the machining path generated by the post-processing unit 11d, and receives, from the numerical controller of the CNC machine tool 4, a signal indicating that the machining by the CNC machine tool 4 is completed so as to display the completion of the machining.

In the machining performance processing, the performance management unit 11f indicates, to the machining monitor unit 11g, the state amount acquisition conditions including the state amount indicating the state of the machining and the sampling cycle for acquiring the state amount, and acquires the machining performance data indicating the history of the machining performed based on the machining command data. Furthermore, the performance management unit 11f sequentially stores the acquired machining performance data in the machining information DB 1A. In the present embodiment, the performance management unit 11f changes, based on the state of the machining (the result of the measurement of the measurement device 6 and the signal indicating the state of the machining performance processing), for each of the machining units, the state amount acquisition conditions such as the state amount indicating the state of the machining and the sampling cycle for acquiring the state amount. Although as the state of the machining, the results of various types of measurements with the measurement device 6 and various types of signals indicating the state of the machining performance processing can be referenced, in the present embodiment, the output of the acoustic sensor in the measurement device 6 is assumed to be referenced. When the output of the acoustic sensor is referenced, a case where an abnormality occurs in machining sound at the time of the machining or the like can be detected as a variation in the state of the machining.

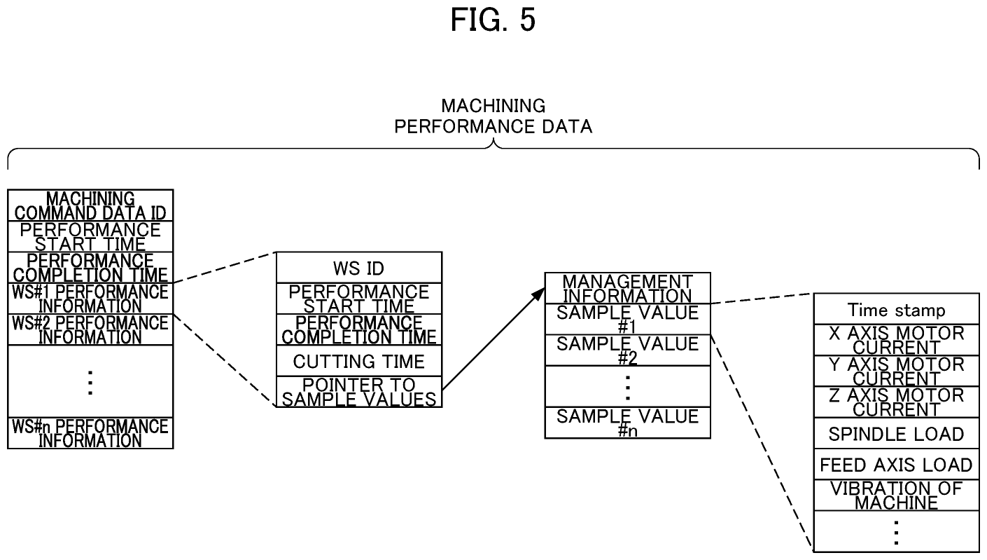

FIG. 5 is a schematic view showing a specific example of the machining performance data. As shown in FIG. 5, the machining performance data includes an ID for the corresponding machining command data, the performance start time of the machining, the performance completion time of the machining and the performance information of the first to nth working steps.

The performance information of the working step includes an ID for the working step, the performance start time of the working step, the performance completion time of the working step, a cutting time and a pointer to sample values. The data of sample values indicated by the pointer to sample values includes management information including the ID for the machining command data and the ID for the working step and the first to nth sample values. The individual sample values include, for example, various types of data which include the time stamp, an X axis motor current, a Y axis motor current, a Z axis motor current, a spindle load, a feed axis load and vibrations of the machine.

With reference back to FIG. 4, the machining monitor unit 11g acquires, according to the state amount acquisition conditions indicated by the performance management unit 11f, the state amount indicating the state of the machining from the numerical controller of the CNC machine tool 4. The state amount indicating the state of the machining includes, for example, various types of data which include the time stamp, the X axis motor current, the Y axis motor current, the Z axis motor current, the spindle load, the feed axis load and vibrations of the machine, and among them, data which is required according to the state of the machining is acquired sequentially.

In the ROM 12, various types of system programs for controlling the machining information recording device 1 are previously written. The RAM 13 is formed with a semiconductor memory such as a DRAM (Dynamic Random Access Memory), and stores data generated when the CPU 11 executes various types of processing. The input unit 14 is formed with an input device such as a keyboard or a mouse, and receives inputs of various types of information to the machining information recording device 1 by the user.

The display unit 15 is formed with a display device such as an LCD (Liquid Crystal Display), and displays the results of various types of processing of the machining information recording device 1. The storage unit 16 is formed with a nonvolatile storage device such as a hard disk or a flash memory, and stores a program for the machining performance processing and the like. In the storage unit 16, the machining information DB 1A is also stored. The communication unit 17 includes a communication interface which performs signal processing based on predetermined communication standards, such as wired or wireless LAN or USB, and controls communication between the machining information recording device 1 and other devices.

[Operation]

The operation of the machining information recording system S will be described next.

### [Machining Performance Processing]

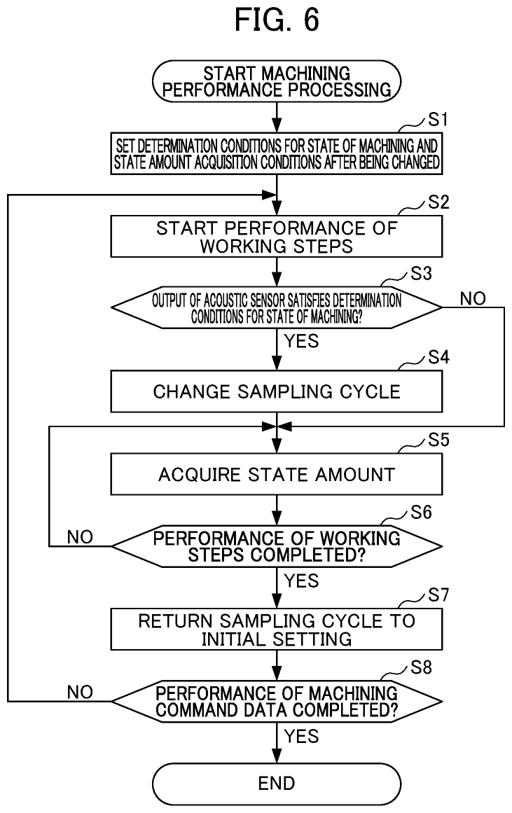

FIG. 6 is a flowchart illustrating the flow of the machining performance processing which is performed by the machining information recording device 1. The machining performance processing is started by inputting, through the input unit 14, an instruction to start up the machining performance processing. In step S1, the performance management unit 11f sets determination conditions for the state of the machining (conditions for changing the state amount acquisition conditions) and the state amount acquisition conditions after being changed (here, the sampling cycle). In the present embodiment, as the determination conditions for the state of the machining, a sudden variation in the output of the acoustic sensor (whose frequency or sound level varies by a set threshold value or greater) is set. The setting in step S1 can be made such as by an operator inputting through the input unit 14 or by reading and inputting a previously prepared setting file.

In step S2, the performance management unit 11f starts the performance of the working steps in the machining command data. Here, the performance management unit 11f performs the working steps whose performance is not completed in the machining command data one by one in the order described in the machining command data. In step S3, the performance management unit 11f determines whether or not the output of the acoustic sensor satisfies the determination conditions for the state of the machining. When the output of the acoustic sensor does not satisfy the determination conditions for the state of the machining, the determination in step S3 is no, and the processing is transferred to step S5. On the other hand, when the output of the acoustic sensor satisfies the determination conditions for the state of the machining, the determination in step S3 is yes, and the processing is transferred to step S4.

In step S4, the performance management unit 11f changes to the state amount acquisition conditions (sampling cycle) after being changed which are set in step S1. In step S5, the machining monitor unit 11g acquires the state amount indicating the state of the machining which is set as the state amount acquisition conditions. The acquired state amount is stored as the machining performance data in the machining information DB 1A.

In step S6, the performance management unit 11f determines whether or not the performance of the working steps is completed. When the performance of the working steps is not completed, the determination in step S6 is no, and the processing is transferred to step S5. On the other hand, when the performance of the working steps is completed, the determination in step S6 is yes, and the processing is transferred to step S7.

In step S7, the performance management unit 11f returns the state amount acquisition conditions (sampling cycle) to the initial setting (the state in step S1). In step S8, the performance management unit 11f determines whether or not the performance of the machining command data is completed. When the performance of the machining command data is not completed, the determination in step S8 is no, and the processing is transferred to step S2. On the other hand, when the performance of the machining command data is completed, the determination in step S8 is yes, and the machining performance processing is completed.

By the processing as described above, in the machining information recording system S, the machining command data is configured as structured data having a hierarchical structure, and thus the machining is performed for each of the working steps serving as the machining units. Then, when the machining information recording device 1 acquires the machining performance data, the sampling cycle (state amount acquisition conditions) for acquiring the state amount indicating the state of the machining is changed according to the state of the machining for each of the machining units. Hence, when the machining of the workpiece is performed, the method of acquiring the machining performance data can be switched to a more appropriate method for each of the machining units. Therefore, with the machining information recording system S according to the present embodiment, it is possible to more appropriately acquire the machining information on the machine tool.

### Second Embodiment

A second embodiment of the present invention will be described next. In the first embodiment, the state amount indicating the state of the machining, the sampling cycle for acquiring the state amount and the like are changed according to the state of the machining for each of the machining units. By contrast, the state amount indicating the state of the machining can be acquired only when determination conditions for the details of the machining are satisfied for each of the machining units. In this case, the system configuration of the machining information recording system S is the same as the system configuration in the first embodiment shown in FIG. 1. The configuration of the performance management unit 11f in the machining information recording device 1 and the machining performance processing which are different from those in the first embodiment will be described below.

In the present embodiment, the performance management unit 11f also functions as a machining performance unit so as to manage the machining performance processing (machining processing based on the machining command data) for performing the machining of the product. For example, the performance management unit 11f receives, from the numerical controller of the CNC machine tool 4, the signal indicating that the standby of the CNC machine tool 4 is completed so as to provide an instruction to start the machining based on the machining path generated by the post-processing unit 11d, and receives, from the numerical controller of the CNC machine tool 4, the signal indicating that the machining by the CNC machine tool 4 is completed so as to display the completion of the machining.

The performance management unit 11f determines, in the machining performance processing, for each of the machining units, whether or not the machined shape (such as the pocket) and the tool used (such as the tool of a specific ID) are previously specified. Then, when the machined shape (such as the pocket) and the tool used (such as the tool of a specific ID) are previously specified for the machining unit (working step) which is performed, the performance management unit 11f indicates, to the machining monitor unit 11g, the state amount acquisition conditions including the state amount which is acquired and the sampling cycle for acquiring the state amount, and acquires the machining performance data indicating the history of the machining performed based on the machining command data. Furthermore, the performance management unit 11f sequentially stores the acquired machining performance data in the machining information DB 1A.

[Operation]

The operation of the machining information recording system S will be described next.

### [Machining Performance Processing]

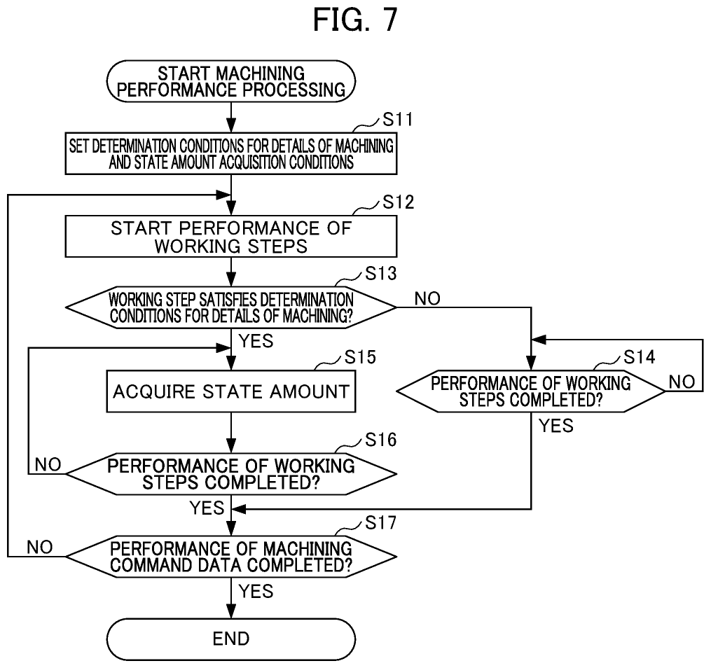

FIG. 7 is a flowchart illustrating the flow of the machining performance processing which is performed by the machining information recording device 1. The machining performance processing is started by inputting, through the input unit 14, an instruction to start up the machining performance processing.

In step S11, the performance management unit 11f sets the determination conditions for the details of the machining (conditions for performing the acquisition of the state amount) and the state amount acquisition conditions at the time of acquisition of the state amount (here, the state amount to be acquired and the sampling cycle for the state amount). In the present embodiment, as the determination conditions for the details of the machining, a setting is made such that in the working step, the machined shape is the pocket and that the tool used in the working step has a specific ID. As the state amount acquisition conditions, a setting is made such that the state amount to be acquired is the spindle load and that the sampling cycle is provided for the spindle load. The setting in step S11 can be made such as by the operator inputting through the input unit 14 or by reading and inputting a previously prepared setting file.

In step S12, the performance management unit 11f starts the performance of the working steps in the machining command data. Here, the performance management unit 11f performs the working steps whose performance is not completed in the machining command data one by one in the order described in the machining command data. In step S13, the performance management unit 11f determines whether or not the working step for starting the performance satisfies the determination conditions for the details of the machining. When the working step for starting the performance does not satisfy the determination conditions for the details of the machining, the determination in step S13 is no, and the processing is transferred to step S14. On the other hand, when the working step for starting the performance satisfies the determination conditions for the details of the machining, the determination in step S13 is yes, and the processing is transferred to step S15.

In step S14, the performance management unit 11f determines whether or not the performance of the working steps is completed. When the performance of the working steps is not completed, the determination in step S14 is no, and the processing in step S14 is repeated. On the other hand, when the performance of the working steps is completed, the determination in step S14 is yes, and the processing is transferred to step S17.

In step S15, the machining monitor unit 11g acquires the state amount (here, the spindle load) set as the state amount acquisition conditions and indicating the state of the machining. The acquired state amount is stored as the machining performance data in the machining information DB 1A. In step S16, the performance management unit 11f determines whether or not the performance of the working steps is completed. When the performance of the working steps is not completed, the determination in step S16 is no, and the processing is transferred to step S15. On the other hand, when the performance of the working steps is completed, the determination in step S16 is yes, and the processing is transferred to step S17.

In step S17, the performance management unit 11f determines whether or not the performance of the machining command data is completed. When the performance of the machining command data is not completed, the determination in step S17 is no, and the processing is transferred to step S12. On the other hand, when the performance of the machining command data is completed, the determination in step S17 is yes, and the machining performance processing is completed.

By the processing as described above, in the machining information recording system S of the present embodiment, the machining command data is configured as structured data having a hierarchical structure, and thus the machining is performed for each of the working steps serving as the machining units. Then, when the machining information recording device 1 performs the machining performance data, only if the determination conditions for the details of the machining are satisfied for each of the machining units, the state amount which is set to the state amount acquisition conditions is acquired in the set sampling cycle. Hence, when the workpiece is machined, the target machining performance data can be selected and acquired for each of the machining units. Therefore, with the machining information recording system S according to the present embodiment, it is possible to more appropriately acquire the machining information on the machine tool.

### Third Embodiment

A third embodiment of the present invention will be described next. The machining information recording system S of the present embodiment differs from those of the first embodiment and the second embodiment in that the state amount acquisition conditions are automatically set for each of the working steps in the machining command data. The system configuration of the machining information recording system S is the same as the system configuration in the first embodiment shown in FIG. 1. The configuration of the machining information recording device 1 and the operation of the machining information recording system S which are different from those in the first embodiment and the second embodiment will be described below.

[Configuration of Machining Information Recording Device 1]

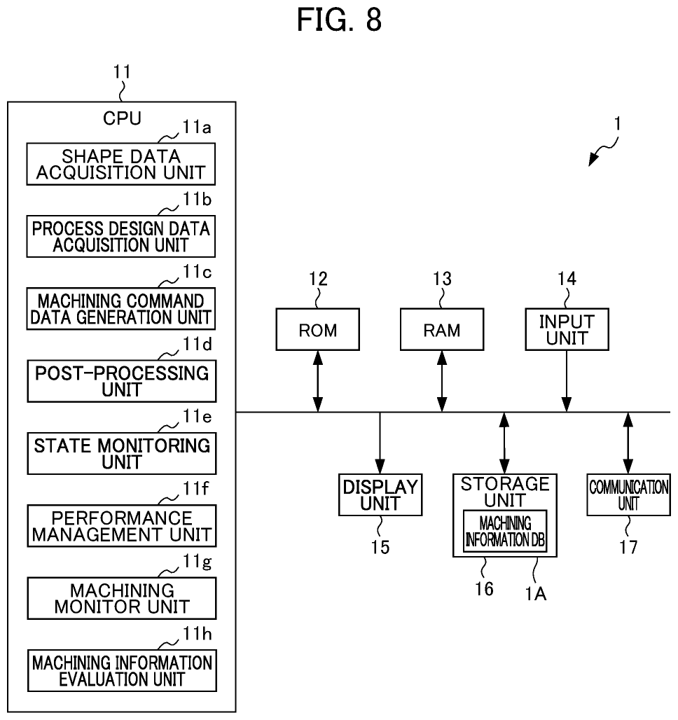

FIG. 8 is a block diagram showing the configuration of the machining information recording device 1 according to the present embodiment. The machining information recording device 1 according to the present embodiment performs the machining performance processing and processing (hereinafter referred to as “machining information evaluation processing”) which evaluates the effectiveness of the machining performance data acquired in the past.

When the machining performance processing and the machining information evaluation processing are performed, in the CPU 11, as a functional configuration, the shape data acquisition unit 11a, the process design data acquisition unit 11b, the machining command data generation unit 11c, the post-processing unit 11d, the state monitoring unit 11e, the performance management unit 11f, the machining monitor unit 11g and a machining information evaluation unit 11h are formed. Among them, the configuration other than the machining information evaluation unit 11h and the performance management unit 11f is the same as in the block diagram of the first embodiment shown in FIG. 4.

The machining information evaluation unit 11h references the machining performance data recorded in the machining information DB 1A so as to determine about each piece of the machining performance data whether or not information which is effective as the machining performance data is acquired (evaluate the machining performance data). Here, the machining information evaluation unit 11h determines, for each of the machining units (working steps), whether or not effective information is acquired. Whether or not the information is effective information can be determined by receiving an input of the result of the determination of the operator, can be automatically determined by whether the acquired information exceeds a threshold value (for example, a threshold value for detecting an abnormality) which is set or can be determined by a combination thereof. Then, the machining information evaluation unit 11h stores, as an effective method of acquiring information (hereinafter also referred to as the “effective information acquisition method”), in the machining information DB 1A, the state amount acquisition conditions for the machining performance data under which the effective information is determined to be acquired. In the present embodiment, the machined shape, the machining method, the tool, the state amount which is acquired and the sampling cycle for the state amount are stored as the effective information acquisition method.

In the present embodiment, the performance management unit 11f manages the machining performance processing for performing the machining of the product (machining processing based on the machining command data). For example, the performance management unit 11f receives, from the numerical controller of the CNC machine tool 4, the signal indicating that the standby of the CNC machine tool 4 is completed so as to provide an instruction to start the machining based on the machining path generated by the post-processing unit 11d, and receives, from the numerical controller of the CNC machine tool 4, the signal indicating that the machining by the CNC machine tool 4 is completed so as to display the completion of the machining.

In the machining performance processing, the performance management unit 11f references the effective information acquisition method stored in the machining information DB 1A so as to search for a satisfactory effective information acquisition method for each of the machining units (working steps) in the machining command data. Then, when the satisfactory effective information acquisition method is found, the performance management unit 11f sets the state amount acquisition conditions for the machining unit (working step) to the effective information acquisition method. When the satisfactory effective information acquisition method is not found, the performance management unit 11f can set a standard state amount and a standard sampling cycle, which are preset, as the state amount acquisition conditions. In this way, the performance management unit 11f automatically sets the state amount acquisition conditions for each of all the machining units (working steps).

The performance management unit 11f indicates, to the machining monitor unit 11g, the state amount acquisition conditions for each of the machining units (working steps) which are set as described above so as to acquire the machining performance data indicating the history of the machining performed based on the machining command data. Furthermore, the performance management unit 11f sequentially stores the acquired machining performance data in the machining information DB 1A.

[Operation]

The operation of the machining information recording system S will be described next.

### [Machining Information Evaluation Processing]

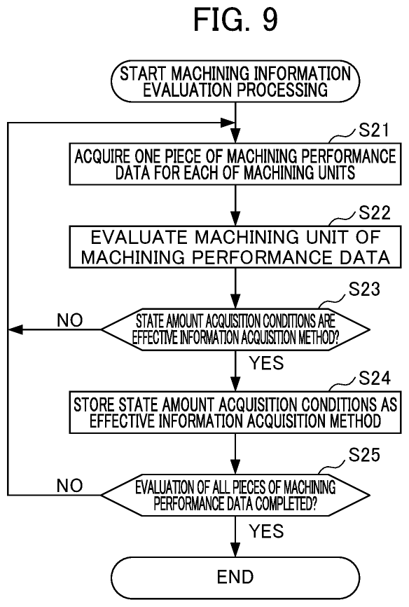

FIG. 9 is a flowchart illustrating the flow of the machining information evaluation processing which is performed by the machining information recording device 1. The machining information evaluation processing is started by inputting, through the input unit 14, an instruction to start up the machining information evaluation processing. In step S21, the machining information evaluation unit 11h acquires one piece of machining performance data stored in the machining information DB 1A for each of the machining units (working steps). In step S22, the machining information evaluation unit 11h evaluates the machining unit in the acquired machining performance data.

In step S23, the machining information evaluation unit 11h determines whether or not the state amount acquisition conditions for the machining unit in the acquired machining performance data are the effective information acquisition method. When the state amount acquisition conditions for the machining unit in the acquired machining performance data are not the effective information acquisition method, the determination in step S23 is no, and the processing is transferred to step S21. On the other hand, when the state amount acquisition conditions for the machining unit in the acquired machining performance data are the effective information acquisition method, the determination in step S23 is yes, and the processing is transferred to step S24.

In step S24, the machining information evaluation unit 11h stores, as the effective information acquisition method, in the machining information DB 1A, the state amount acquisition conditions for the machining unit in the acquired machining performance data. In step S25, the machining information evaluation unit 11h determines whether or not the evaluation of all the pieces of machining performance data stored in the machining information DB 1A is completed. When the evaluation of all the pieces of machining performance data stored in the machining information DB 1A is not completed, the determination in step S25 is no, and the processing is transferred to step S21. On the other hand, when the evaluation of all the pieces of machining performance data stored in the machining information DB 1A is completed, the determination in step S25 is yes, and the machining information evaluation processing is completed.

[Machining Performance Processing]

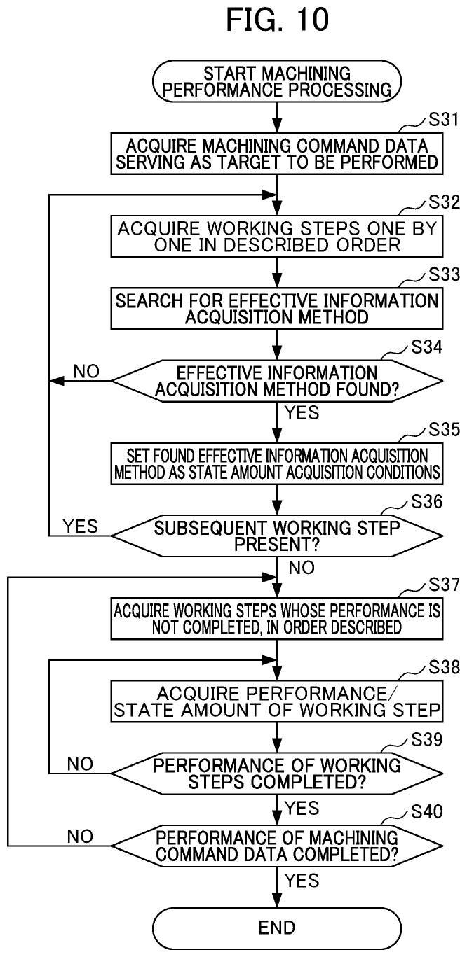

FIG. 10 is a flowchart illustrating the flow of the machining performance processing which is performed by the machining information recording device 1. The machining performance processing is started by inputting, through the input unit 14, an instruction to start up the machining performance processing. In step S31, the performance management unit 11f acquires the machining command data serving as a target to be performed. In step S32, the performance management unit 11f acquires the working steps included in the machining command data one by one in the order described in the machining command data. In step S33, the performance management unit 11f references the machining information DB 1A so as to search for the effective information acquisition method which is satisfactory for the acquired working step.

In step S34, the performance management unit 11f determines whether or not the effective information acquisition method satisfactory for the acquired working step is found. When the effective information acquisition method satisfactory for the acquired working step is not found, the determination in step S34 is no, and the processing is transferred to step S32. In this case, standard state amount acquisition conditions are set for the acquired working step. On the other hand, when the effective information acquisition method satisfactory for the acquired working step is found, the determination in step S34 is yes, and the processing is transferred to step S35.

In step S35, the performance management unit 11f sets the found effective information acquisition method as the state amount acquisition conditions for the acquired working step. In step S36, the performance management unit 11f determines whether or not the machining command data serving as the target to be performed includes the subsequent working step. When the machining command data serving as the target to be performed includes the subsequent working step, the determination in step S36 is yes, and the processing is transferred to step S32. On the other hand, when the machining command data serving as the target to be performed does not include the subsequent working step, the determination in step S36 is no, and the processing is transferred to step S37.

In step S37, the performance management unit 11f acquires the working steps whose performance is not completed in the machining command data one by one in the order described in the machining command data. In step S38, the performance management unit 11f performs the acquired working step, and acquires the state amount according to the effective information acquisition method set for the performed working step.

In step S39, the performance management unit 11f determines whether or not the performance of the working steps is completed. When the performance of the working steps is not completed, the determination in step S39 is no, and the processing is transferred to step S38. On the other hand, when the performance of the working steps is completed, the determination in step S39 is yes, and the processing is transferred to step S40.

In step S40, the performance management unit 11f determines whether or not the performance of the machining command data is completed. When the performance of the machining command data is not completed, the determination in step S40 is no, and the processing is transferred to step S37. On the other hand, when the performance of the machining command data is completed, the determination in step S40 is yes, and the machining performance processing is completed.

By the processing as described above, it is possible to extract and store, for each of the machining units, as the effective information acquisition method, the state amount acquisition conditions when the appropriate state amount is acquired in the machining performance data stored in the machining information DB 1A. Then, in the performance of the subsequent machining command data, an appropriate effective information acquisition method (state amount acquisition conditions) can be set for each of the machining units, and the state amount can be acquired. Hence, with the machining information recording system S according to the present embodiment, it is possible to more appropriately acquire the machining information on the machine tool.

The present invention is not limited to the embodiments and variations described above and various modifications, variations and the like are possible. For example, the configurations of the individual embodiments described above can be combined so as to be practiced. As an example, the first embodiment and the second embodiment can be combined, and thus the following configuration can be achieved. Specifically, for each of the machining units of the workpiece, whether or not the determination conditions for the details of the machining are satisfied is determined, and when the determination conditions are satisfied, based on the state of the machining of the workpiece, the state amount and the sampling cycle which are acquired are changed, with the result that it is possible to set the state amount acquisition conditions as necessary. The first embodiment, the second embodiment and the third embodiment can be combined, and thus the following configuration can also be achieved. Specifically, for each of the machining units of the workpiece, whether or not the determination conditions for the details of the machining are satisfied can be determined, and when the determination conditions are satisfied, the state amount acquisition conditions (the effective information acquisition conditions or the standard state amount acquisition conditions) set in the third embodiment for each of the machining units can be used as the initial values, with the result that it is possible to perform the machining of the workpiece. Then, for each of the machining units, based on the state of the machining of the workpiece, the state amount or the sampling cycle which is acquired can be further changed, and thus it is possible to set the state amount acquisition conditions as necessary.

Although in the embodiments described above, the machining information DB 1A is included in the machining information recording device 1, there is no limitation to this configuration. In other words, the machining information DB 1A may be included in another device with which the machining information recording device 1 can communicate through a network. The details of the machining command data, the machining performance data or the like stored in the machining information DB 1A are described as one example, and data corresponding to various types of machining steps in the production process can be stored and managed.

The whole or part of the functions of the machining information recording system S according to the embodiments described above can be realized by hardware, software or a combination thereof. Here, the realization by software means that a processor reads and executes programs so as to achieve the realization. When the whole or part thereof is formed by hardware, part or the whole of the functions of the machining information recording system S can be formed with an integrated circuit (IC) such as an ASIC (Application Specific Integrated Circuit), a gate array, an FPGA (Field Programmable Gate Array) or a CPLD (Complex Programmable Logic Device).

When the whole or part of the functions of the machining information recording system S is formed by software, in a computer formed with a storage unit, such as a hard disk or a ROM, which stores programs describing the whole or part of the functions of the machining information recording system S, a DRAM which stores data necessary for operations, a CPU and a bus connecting each of the units, information necessary for operations is stored in the DRAM, and the programs are operated with the CPU, with the result that the whole or part thereof can be realized.

These programs are stored using various types of computer readable media, and can be supplied to the computer. The computer readable media include various types of tangible recording media (tangible storage media). Examples of the computer readable medium include magnetic recording media (for example, a flexible disk, a magnetic tape and a hard disk drive), magneto-optical recording media (for example, a magneto-optical disk), a CD-ROM (Read Only Memory), a CD-R, a CD-R/W, a DVD-ROM (Digital Versatile Disk), a DVD-R, a DVD-R/W and semiconductor memories (for example, a mask ROM, a PROM (Programmable ROM), an EPROM (Erasable PROM), a flash memory and a RAM (Random Access Memory)). These programs may be downloaded to the computers of users through a network so as to be distributed.

Although the embodiments of the present invention are described in detail above, the embodiments described above simply show specific examples for practicing the present invention. The technical scope of the present invention is not limited to the embodiments described above. In the present invention, various modifications are possible without departing from the spirit thereof, and they are also included in the technical scope of the present invention.

### EXPLANATION OF REFERENCE NUMERALS

S machining information recording system
1 machining information recording device
1A machining information DB (database storing data of state amount)
2 CAD system
3 CAM system
4 CNC machine tool (machine tool)
5 peripheral equipment
6 measurement device
11 CPU
11a shape data acquisition unit
11b process design data acquisition unit
11c machining command data generation unit
11d post-processing unit
11e state monitoring unit
11f performance management unit (acquisition condition setting unit, acquisition control unit, machining performance unit)
11g machining monitor unit (state amount acquisition unit)
11h machining information evaluation unit
12 ROM
13 RAM
14 input unit
15 display unit
16 storage unit
17 communication unit

What is claimed is:

1. A machining information recording device comprising: a state amount acquisition unit which acquires a state amount indicating a state of machining that is performed with a machine tool;
an acquisition condition setting unit which sets, based on the state of the machining, a state amount acquisition condition for acquiring the state amount; and
an acquisition control unit which controls the acquisition of the state amount by the state amount acquisition unit based on the state amount acquisition condition set by the acquisition condition setting unit.

2. The machining information recording device according to claim 1, wherein the acquisition condition setting unit sets, based on the state of the machining, as the state amount acquisition condition, at least any one of the state amount which is acquired in a machining step included in the machining and a sampling cycle for acquiring the state amount.

3. The machining information recording device according to claim 1, wherein when details of a machining step included in the machining satisfy a preset condition, the acquisition condition setting unit sets, as the state amount acquisition condition, the state amount acquired in the machining step.

4. The machining information recording device according to claim 1, wherein the acquisition condition setting unit sets, based on machining command data for the machining, the state amount acquisition condition for acquiring the state amount in a machining step included in the machining before the machining is performed.

5. A machining information recording device comprising: a machining information evaluation unit which references a database storing machining command data of machining performed with a machine tool and data of a state amount acquired in the machining and indicating a state of the machining so as to evaluate effectiveness of a state amount acquisition condition indicating an acquisition condition when the state amount is acquired in the machining;
an acquisition condition setting unit which sets, for each of machining steps included in the machining command data serving as a target to be performed, based on details of machining in the machining step and a result of the evaluation of the machining information evaluation unit, the state amount acquisition condition for the machining step;
a machining performance unit which performs, based on the state amount acquisition condition for each of the machining steps that is set by the acquisition condition setting unit, machining of a workpiece with the machining command data serving as the target to be performed; and
a state amount acquisition unit which acquires a state amount indicating a state of the machining of the workpiece performed by the machining performance unit.

6. A machining information recording method comprising: a state amount acquisition step of acquiring a state amount indicating a state of machining that is performed with a machine tool;
an acquisition condition setting step of setting, based on the state of the machining, a state amount acquisition condition for acquiring the state amount; and
an acquisition control step of controlling the acquisition of the state amount in the state amount acquisition step based on the state amount acquisition condition set in the acquisition condition setting step.

7. A machining information recording method comprising: a machining information evaluation step of referencing a database storing machining command data of machining performed with a machine tool and data of a state amount acquired in the machining and indicating a state of the machining so as to evaluate effectiveness of a state amount acquisition condition indicating an acquisition condition when the state amount is acquired in the machining;
an acquisition condition setting step of setting, for each of machining steps included in the machining command data serving as a target to be performed, based on details of machining in the machining step and a result of the evaluation of the machining information evaluation unit, the state amount acquisition condition for the machining step;
a machining performance step of performing, based on the state amount acquisition condition for each of the machining steps that is set in the acquisition condition setting step, machining of a workpiece with the machining command data serving as the target to be performed; and
a state amount acquisition step of acquiring a state amount indicating a state of the machining of the workpiece performed in the machining performance step.

8. A non-transitory computer readable medium recording a program that instructs a computer to realize:
a state amount acquisition function of acquiring a state amount indicating a state of machining that is performed with a machine tool;
an acquisition condition setting function of setting, based on the state of the machining, a state amount acquisition condition for acquiring the state amount; and
an acquisition control function of controlling the acquisition of the state amount in the state amount acquisition function based on the state amount acquisition condition set in the acquisition condition setting function.

9. A non-transitory computer readable medium recording a program that instructs a computer to realize:
a machining information evaluation function of referencing a database storing machining command data of machining performed with a machine tool and data of a state amount acquired in the machining and indicating a state of the machining so as to evaluate effectiveness of a state amount acquisition condition indicating an acquisition condition when the state amount is acquired in the machining;
an acquisition condition setting function of setting, for each of machining steps included in the machining command data serving as a target to be performed, based on details of machining in the machining step and a result of the evaluation of the machining information evaluation function, the state amount acquisition condition for the machining step;
a machining performance function of performing, based on the state amount acquisition condition for each of the machining steps that is set in the acquisition condition setting function, machining of a workpiece with the machining command data serving as the target to be performed; and
a state amount acquisition function of acquiring a state amount indicating a state of the machining of the workpiece performed in the machining performance function.
